(19) United States
(12) Patent Application Publication
(10) Pub. No.: US 2012/0224368 A1
(43) Pub. Date: Sep. 6, 2012

(54) Led lamp with high brightness and without overlapping

(75) Inventor: Takeho Hsu, Taipei City (TW)

(73) Assignee: Xing-Xiong Technology Co., Ltd.

(21) Appl. No.: 13/374,320

(22) Filed: Dec. 21, 2011

(30) Foreign Application Priority Data
Mar. 4, 2011 (TW) 100205247
Aug. 2, 2011 (TW) 100214288

(51) Int. Cl. F21V 7/00; F21V 29/00

(52) U.S. Cl. 362/235

(57) ABSTRACT

A LED lamp with high brightness and without overlapping includes a lamp shell, two LED modules, a secondary optical element and reflecting projections. The lamp shell has an inner accommodating space with one side formed with an opening. Each LED module is disposed in the accommodating space and has LED dies. The secondary optical element is disposed at the opening and has a light-permeable portion. The projections are formed on the light-permeable portions. The light rays emitted from each LED module form a light area, the light rays of the neighboring light areas partially overlap with each other to form a light intersecting position, and the light-permeable portion passes through each light intersecting position. Also, the light rays, emitted from the LED modules, are projected onto the surfaces of the projections for reflection to decrease the light loss, increase the brightness, homogenize the light rays and eliminate the glare.

### BACKGROUND OF THE INVENTION

1. Field of the Invention

The invention relates to the technological field of a road lamp, and more particularly to a light-emitting diode (LED) road lamp with high brightness and without overlapping, and the LED road lamp uses LEDs as light emitting sources and works in conjunction with a heat-dissipating device.

2. Related Art

Because the LED has the properties, such as the small size, the light weight and the long lifetime, and can save the power in use, many lamps, such as indoor illumination lamps, desk lamps, dome lamps or even outdoor road lamps, billboards or the like, adopt the LEDs as the light sources.

For example, the LED road lamp has a light bulb or a light strip composed of multiple LEDs, and each light bulb or light strip may function as a light source to provide the sufficient brightness and illumination area.

In general, as shown in FIG. 1A, two light sources 100 and 101 illuminate an object 102, and shadows 103 and 104 are respectively produced. As shown in FIG. 1B, the two shadows 103 and 104 partially overlap with each other to form the overlapping when the distances between the object 102 and the light sources 100 and 101 are changed. Either the two shadows or the overlapping deteriorates the illumination effect.

U.S. Pat. No. 7,513,639 disclosed a LED road lamp including multiple LED modules assembled in a lamp housing having an M-shape base. A light transmitting hood is assembled on the lamp housing and the light rays emitted from the LED modules can penetrate through the light transmitting hood.

Because the LED modules are mounted on the M-shape base, the light rays of the LED modules can illuminate the floor in an inclined direction so that the illumination area is enlarged. However, when the light rays illuminate an object, such as a human or a vehicle, many shadows or overlapping phenomena are produced because each LED module is still an independent light source.

U.S. Pat. No. 7,665,862 disclosed a LED illumination structure, in which a LED light strip is mounted on an inclined surface so that the light rays outputted from each LED illuminate the floor in an inclined direction to enlarge the illumination area. However, when the light rays illuminate an object, many shadows or overlapping phenomena are still produced.

U.S. Pat. No. 7,841,743 disclosed a lighting apparatus having multiple annular or elongated triangular structures, which are uniformly distributed, on a surface of a lens unit (e.g., Fresnel lens), and using two side surfaces of the triangular structure to reflect a portion of the light rays, so that the light rays transmitted through the lens unit become more homogenized.

### SUMMARY OF THE INVENTION

An object of the invention is to provide a LED lamp with high brightness and without overlapping, wherein the LED lamp has the effects of the simple structure and the uniformly transmitted light and has no glare.

In addition, another object of the invention is to provide a LED lamp with high brightness and without overlapping, wherein the LED lamp has the good heat dissipating design capable of effectively and rapidly dissipating the heat generated by the LED road lamp.

According to the above-mentioned objects and effects, the invention discloses a LED lamp with high brightness and without overlapping. The LED lamp includes a lamp shell, two LED modules, a secondary optical element and a plurality of projections. The lamp shell has an inner accommodating space. One side of the accommodating space is formed with an opening. The two LED modules are disposed in the accommodating space of the lamp shell. Each of the LED modules has a plurality of LED dies. The secondary optical element is disposed at the opening of the lamp shell and has a light-permeable portion. The projections are formed on the light-permeable portions of the secondary optical element. The light rays emitted from each of the LED modules form a light area, the light rays of the neighboring light areas partially overlap with each other to form a light intersecting position, and the light-permeable portion of the secondary optical element passes through each of the light intersecting positions. Also, the light rays, emitted from the LED modules, are projected onto each of the projections, which reflects and homogenizes the light rays.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1A is a schematic illustration showing a double shadow caused by two light sources.

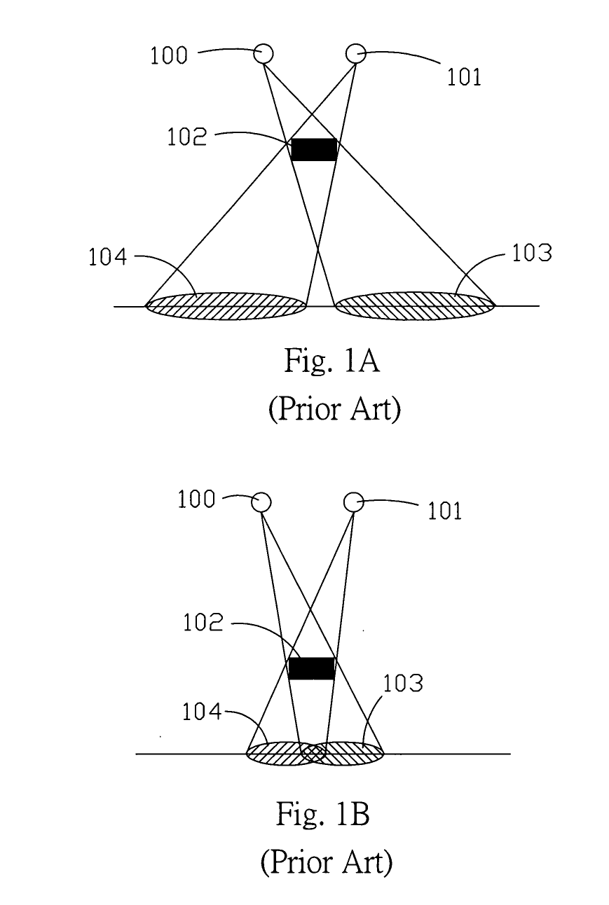

FIG. 1B is a schematic illustration showing overlapping caused by two light sources.

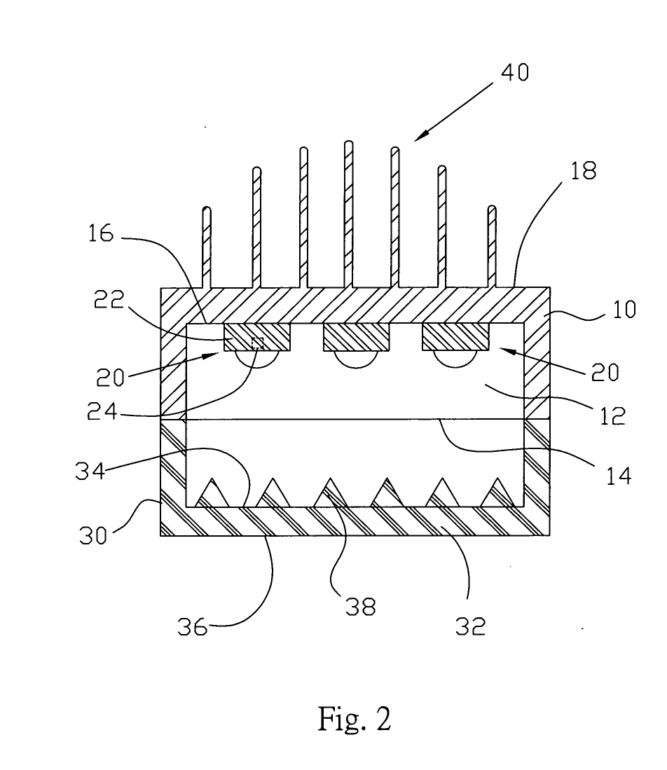

FIG. 2 is a schematic illustration showing a structure of the invention.

FIG. 3 is a schematic illustration showing the structure of the invention.

FIG. 4A shows the exterior of a projection of the invention.

FIG. 4B is a schematic illustration showing the distribution of the projections of the invention.

FIG. 5 shows the exterior of a LED module of the invention.

FIG. 6A is a schematic illustration showing a structure of the LED module of the invention.

FIG. 6B is a schematic illustration showing another structure of the LED module of the invention.

FIG. 7 is a schematic illustration showing light intersecting positions of the LED light source of the invention.

FIGS. 8A to 8C are schematic illustrations showing arrangement position of a secondary optical element of the invention.

FIG. 9 is a schematic illustration showing a used state of the invention.

### DETAILED DESCRIPTION OF THE INVENTION

The present invention will be apparent from the following detailed description, which proceeds with reference to the accompanying drawings, wherein the same references relate to the same elements.

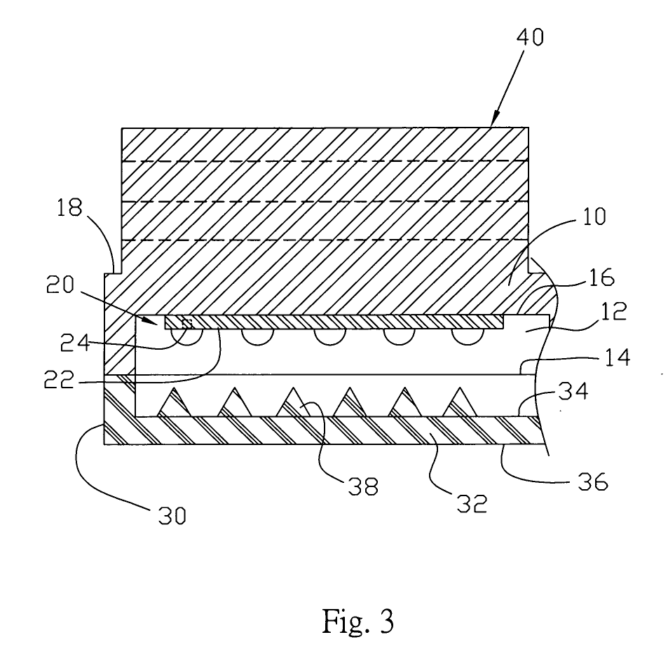

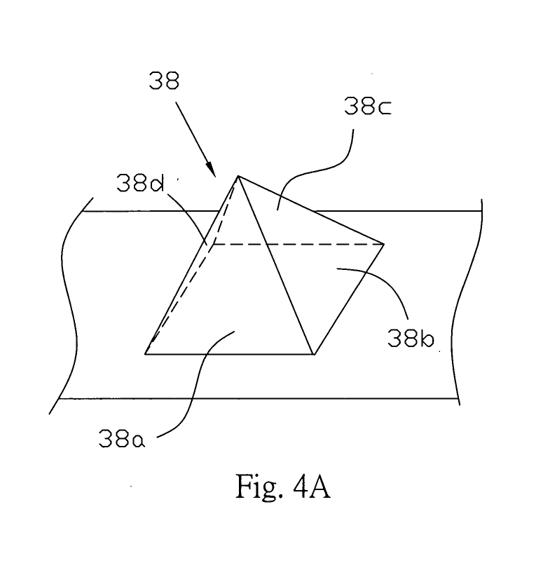

Referring to FIGS. 2 and 3, a LED road lamp includes a lamp shell 10, a plurality of LED modules 20, such as the light strips depicted in the drawings, a secondary optical element 30 and a heat-dissipating device 40.

Specifically, the lamp shell 10 is made of a metal material, and has an inner accommodating space 12, and one side of the accommodating space 12 has an opening 14. The heat-dissipating device 40 is composed of a plurality of fins disposed on an external surface 18 of the lamp shell 10. More particularly, the heat-dissipating device 40 and the lamp shell 10 are integrally formed.

The LED module 20 is composed of a carrier 22 and a plurality of LED dies 24 disposed on the carrier 22. The carrier 22 has circuits (not shown) and each LED die 24 is electrically connected to the circuits of the carrier 22.

Each LED module 20 is disposed in the accommodating space 12, and each carrier 22 is in contact with an inner surface 16 of the lamp shell 10, such that the heat generated by the LED module 20 is conducted to the lamp shell 10. Alternatively, the carrier 22 works in conjunction with other elements or devices to conduct the heat, generated by the LED module 20, to the lamp shell 10. On the other hand, the light rays of each LED die 24 travel in a direction toward the opening 14 on one side of the lamp shell 10.

The secondary optical element 30 is a light-permeable element made of the glass, acrylic, resin or any other similar material. The secondary optical element 30 is disposed at the opening 14 on one side of the lamp shell 10.

In detail, the secondary optical element 30 has a light-permeable portion 32. According to the assembling type and the thickness of the secondary optical element 30, the light-permeable portion 32 has an inner surface 34 and an outer surface 36. It is to be noted that a plurality of projections 38 is further formed on the inner surface 34.

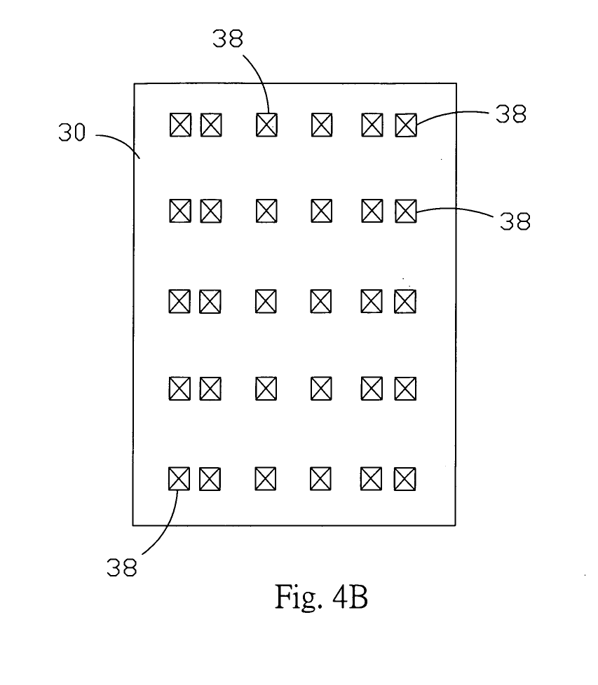

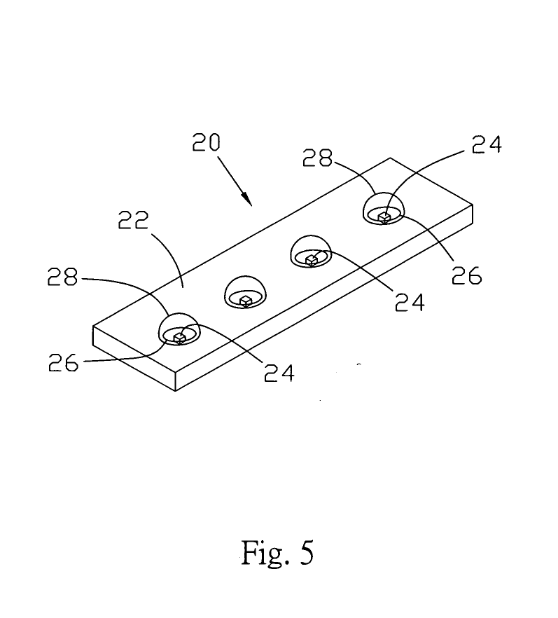

As shown in FIG. 4A, the projection 38 may be a conical block, so the surface of the projection 38 has multiple reflecting surfaces 38a to 38d.

As shown in FIG. 4B, the projections 38 may be uniformly distributed on the secondary optical element 30.

According to the teachings of FIG. 4, the projection 38 may also be a triangular cone having side surfaces formed with three reflecting surfaces. Similarly, the projection 38 may be a pentagonal cone having five reflecting surfaces. As is known, the projection 38 has at least three reflecting surfaces.

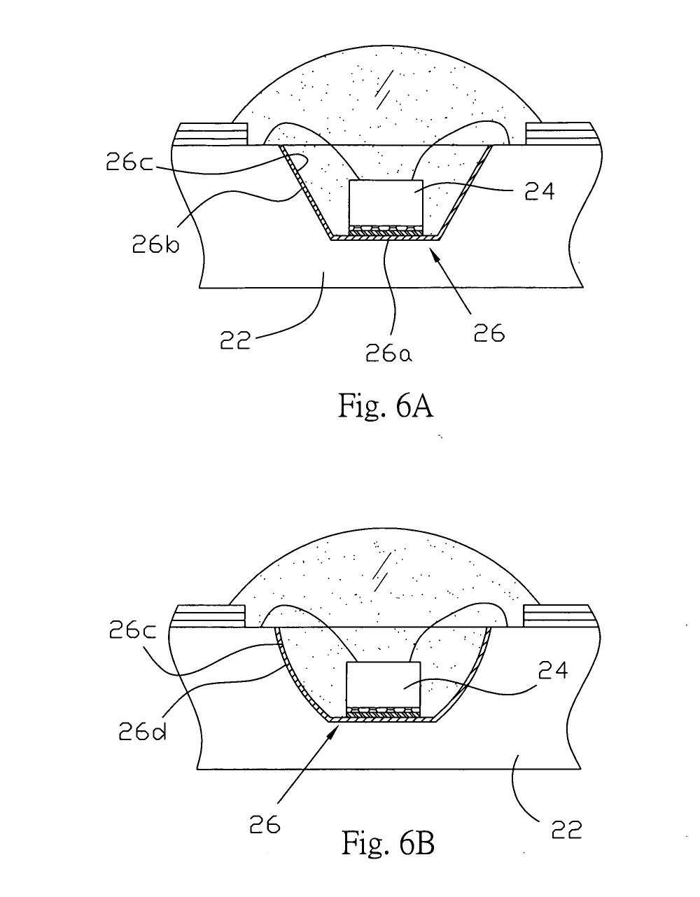

As shown in FIG. 5, the carrier 22 of the LED module 20 is formed with a plurality of accommodating cavities 26 for accommodating the LED dies 24. A package encapsulant 28 contains the fluorescent powder, which is filled into the accommodating cavity 26 and can cover the LED dies 24.

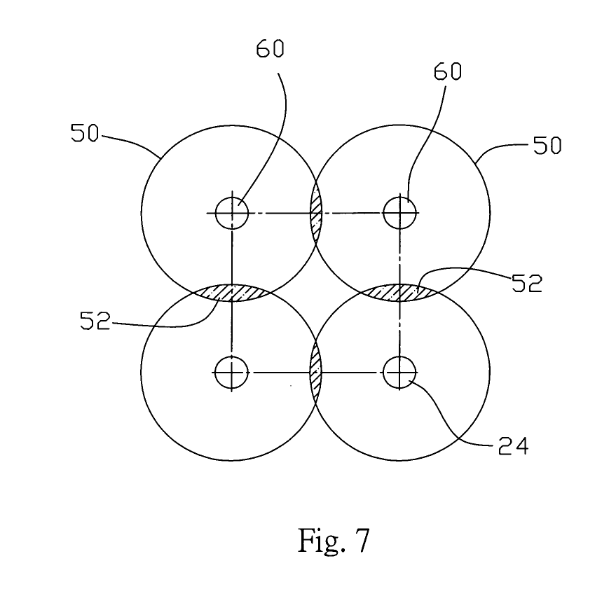

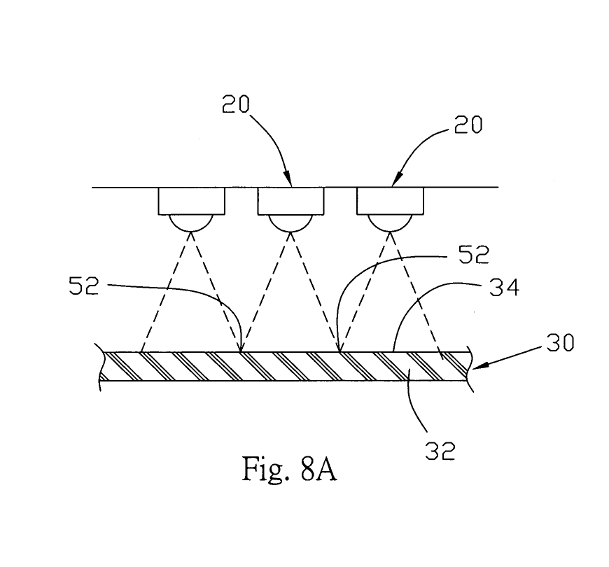

As shown in FIG. 6A, a bottom portion of the accommodating cavity 26 is formed with a platen structure 26a for supporting the LED die 24. A lateral side wall of the accommodating cavity 26 is formed with an inclined surface structure 26b and has a metal coating 26c. The heat generated by the LED die 24 enters the accommodating cavity 26 and can be conducted into the carrier 22 through the metal coating 26c.

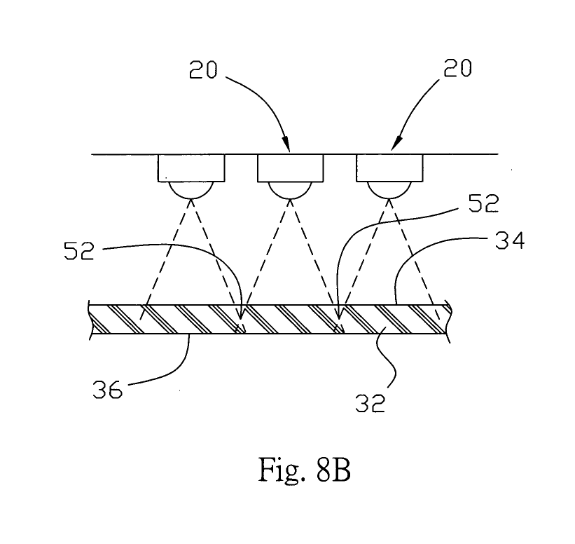

As shown in FIG. 6B, the lateral side wall of the accommodating cavity 26 may be formed with an arced structure 26d and have a surface formed with the metal coating 26c. The heat generated by the LED die 24 can be quickly conducted into the carrier 22 by way of thermal spinning after contacting the arced structure 26d. As shown in FIG. 7, the light rays emitted by a light source 60 constituted by each of the LEDs form a light area 50. In order to prevent a dark area from being formed between the light areas 50 due to no light illumination, the light sources 60 are disposed closer to one another, so that the light areas 50 partially overlap with one another to form light intersecting positions 52. Because the light intersecting position 52 is the position where the light travels, the constructive interference is formed to enhance the brightness if the neighboring light rays have the same phase; and the destructive interference is formed to decrease the brightness if the neighboring light rays have opposite phases. However, the two conditions are not helpful to the uniformity of light.

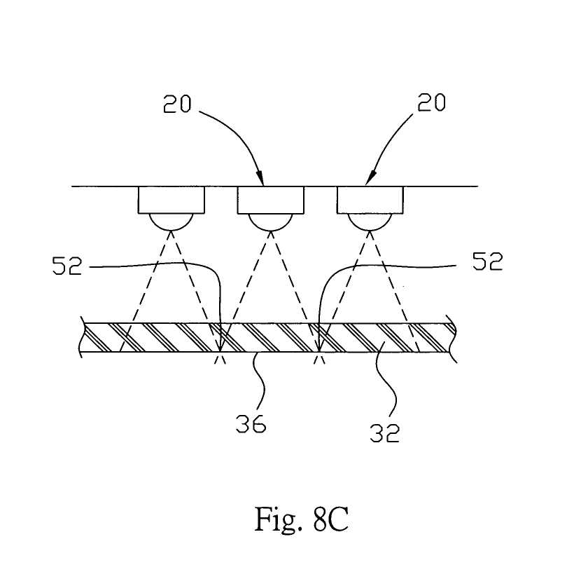

As shown in FIG. 8A, the secondary optical element 30 of this invention is disposed at the light intersecting position 52 of the LED module 20. More particularly, the light intersecting position 52 may be disposed on the inner surface 34 of the light-permeable portion 32.

Similarly, FIG. 8B shows that the light intersecting position 52 of the LED module 20 may be disposed between the inner surface 34 and the outer surface 36 of the light-permeable portion 32. FIG. 8C shows that the light intersecting position 52 of the LED module 20 is disposed on the outer surface 36 of the light-permeable portion 32.

The light intersecting position 52 may be calculated according to the light emitting angle of the LED module 20 and the arrangement position of the LED module 20. Furthermore, the assembling position of the secondary optical element 30 may be properly selected according to the actual state.

By the selection of mounting position of the secondary optical element 30, the interference condition of the light rays can be reduced when the light rays of the LED module 20 travel to the secondary optical element 30, so that the halo or spot produced by each LED module 20 on the surface of the secondary optical element 30 can be eliminated. In other words, the condition of brightness loss of the LED module 20 can be improved by the selection of the assembling position of the secondary optical element 30, and the brightness can be enhanced.

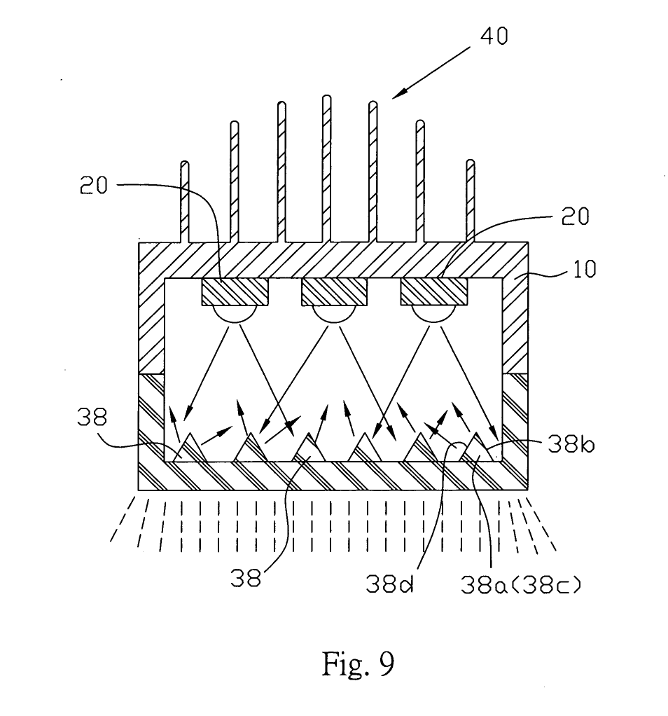

As shown in FIG. 9, when the light rays outputted from the LED module 20 illuminate the projections 38, the reflecting surfaces 38a to 38d can disperse a portion of the light rays so that the light rays become more homogenized. Consequently, the light rays transmitting through the secondary optical element 30 are homogenized, so that the multi-shadow or overlapping phenomenon disappears. Meanwhile, since the light rays are homogenized, no glare condition is produced.

In addition, since the heat-dissipating device 40 and the lamp shell 10 are integrally formed, the heat can be rapidly conducted to the heat-dissipating device 40 and dissipated to the outside when the LED module 20 conducts the heat to the lamp shell 10. Thus, the good heat dissipating property can be obtained, and the lifetime can be lengthened.

According to the above-mentioned descriptions, the invention does not need to design the mechanism for adjusting the mounting angle of the LED module, or does not need to mount the LED module at a different angle. Thus, the structure and the mounting processes are simple. Furthermore, the invention can effectively homogenize the illumination of the light rays according to the arrangement position of the secondary optical element and the projections, each of which has multiple surfaces and is formed on the inner surface of the secondary optical element. Thus, it is possible to decrease the light loss and eliminate the overlapping and glare so that the high brightness and the comfortable effects in use can be provided.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A light-emitting diode (LED) lamp with high brightness and without overlapping, the LED lamp comprising:
a lamp shell having an inner accommodating space, wherein one side of the accommodating space is formed with an opening;
two LED modules disposed in the accommodating space of the lamp shell, wherein each of the LED modules has a plurality of LED dies;
a secondary optical element, which is disposed at the opening of the lamp shell and has a light-permeable portion; and
a plurality of projections, which is disposed on the light-permeable portions of the secondary optical element and has three reflecting surfaces, wherein:
light rays emitted from each of the LED modules form a light area, the light rays of the neighboring light areas partially overlap with each other to form a light intersecting position, and the light-permeable portion of the secondary optical element passes through each of the light intersecting positions; and
the light rays, outputted from the LED module, partially illuminate the reflecting surface of the projection, and the light rays are reflected and transmit through the secondary optical element.

2. The LED lamp according to claim 1, further comprising a heat-dissipating device integrally formed on an external surface of the lamp shell.

3. The LED lamp according to claim 1, wherein the light-permeable portion of the secondary optical element has an inner surface and an outer surface, and the light intersecting position is located on the inner surface.

4. The LED lamp according to claim 1, wherein the light-permeable portion of the secondary optical element has an inner surface and an outer surface, and the light intersecting position is located between the inner surface and the outer surface.

5. The LED lamp according to claim 1, wherein the light-permeable portion of the secondary optical element has an inner surface and an outer surface, and the light intersecting position is located on the outer surface.

6. The LED lamp according to claim 1, wherein the LED module comprises a plurality of LED dies and a carrier, the carrier has a plurality of accommodating cavities, each of which has a bottom portion formed with a platen structure, and the LED die is fixed onto the platen structure.

7. The LED lamp according to claim 6, wherein a lateral side wall of the accommodating cavity is formed with an inclined surface structure and has metal coating.

8. The LED lamp according to claim 6, wherein a lateral side wall of the accommodating cavity is formed with a camber structure and has metal coating.
